(19) United States
(12) Patent Application Publication
(10) Pub. No.: US 2024/0327090 A1
(43) Pub. Date: Oct. 3, 2024

(54) SPLITABLE TEA BAG

(71) Applicant: Josias Jared Hernandez, Seaside, CA (US)

(72) Inventor: Josias Jared Hernandez, Seaside, CA (US)

(21) Appl. No.: 18/126,688

(22) Filed: Mar. 27, 2023

(51) Int. Cl. B65D 75/52; A23F 3/18; B65B 29/02; B65B 61/00; B65D 75/42; B65D 85/812

(52) U.S. Cl. CPC B65D 75/527; A23F 3/18; B65B 29/028; B65B 61/007; B65D 75/42; B65D 85/812

(57) ABSTRACT

Implementations of the disclosure relate to tea bags that are splitable into multiple self-contained smaller portions. Smaller quantities of tea leaves are individually sealed in compartments of a tea bag with a mechanism for splitting built into the tea bag. In one embodiment, the mechanism for splitting can be pre-formed perforations along an axis of symmetry. The perforations can also be along some asymmetrical axis to divide the tea bag into inequal smaller portions. In some embodiments, the mechanism for splitting may not involve a tear, but just a separation of the smaller portions by imparting slight force by hand.

### TECHNICAL FIELD

Implementations of the disclosure relate to tea bags that are splitable into multiple self-contained portions.

### BACKGROUND

Tea is the most widely consumed beverage in the world. Tea has proven health benefits in terms of stimulating mind and body and has many therapeutic usages too. Dried tea leaves can be sold in a bigger package (loose leaf package) from which the user can choose the right quantity to mix in hot water to prepare tea. However, tea bags are popular because of their convenience, where a pre-packed amount of dried tea leaves is sealed within a pouch. The pouch is usually made of some membranous material with micro-pores so that when the pouch is dipped into hot water, water seeps into the pouch and extract liquid tea from the dried leaves through the process of infusion.

Despite the convenience, use of tea bags sometimes leads to wasteful behavior, often unintentionally, since tea bags come with pre-packaged amount of tea leaves. The root cause behind the wastefulness is the fact that the tea drinker has no control over the amount of tea leaves to immerse into hot water, when using a tea bag. The present inventor is motivated to address the unintentional wastefulness associated with tea consumption by proposing a solution.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Implementations of the disclosure relate to tea bags that are splitable into multiple self-contained smaller portions. Smaller quantities of tea leaves can be individually sealed in isolated compartments that are part of one tea bag with a mechanism for splitting built into the tea bag. In one embodiment, the mechanism for splitting can be pre-formed perforations along an axis of symmetry. The perforations can also be along some asymmetrical axis to divide the tea bag into unequal smaller portions. In some embodiments, the mechanism for splitting may not involve a tear, but just a separation of the smaller portions by imparting slight force with hand.

Note that the words “cup” and “mug” are used generically and interchangeably in the specification below to describe a liquid container from which the beverage is being sipped. Also, though the specification mentions “tea” as the beverage, the inventive concept is not limited to tea only, but is applicable to any beverage that can be prepared from infusion of a liquid into pieces of herbs sealed in a pouch with micro-pores to allow passage of liquid. Also, the words “portions” and “compartments” are used interchangeably. Pieces of herb other than tea can be sealed individually in at least one of the compartments, while the other compartment has tea leaves. Alternatively, pieces of herb can be premixed with tea leaves sealed in the compartments.

The present inventor realized that a tea drinker can get two or more cups of tea from one tea bag, depending on how much tea the drinker wants to consume at that moment. One way to avoid wastefulness is to immerse the tea bag in a big mug full of hot water, because it can be annoying going through the inconvenience of saving a wet tea bag for later. Alternatively, one can use multiple cups and dip the tea bag sequentially from one cup to the other, but controlling the right amount of water or controlling the dipping time in each of the cups can be non-intuitive, and can lead to overly strong or overly diluted tea. When the drinker does not have time or access to loose-leaf tea equipment (such as a tea pot, a sieve etc.), and wants to make a smaller quantity of tea, and/or wants to make multiple smaller cups of tea from one tea bag, the ability to “rip a tea bag into multiple portions” is useful. But conventional tea bags are sold with a pre-packaged amount of tea without the ability to “portion-control”, as the tea bags are sealed.

Aspects of the disclosure address the above and other deficiencies by giving the option to efficiently get two or more servings of tea from one tea bag. The drinker may want to share tea with another person(s) and have the perfect amount of tea for each person. Alternatively, the drinker may only want to have smaller quantity of tea at the moment and want to save some for later.

Specifically, the present disclosure claims a splitable tea bag, comprising: a plurality of compartments with respective amounts of tea leaves sealed inside each compartment; and, a mechanism for splitting the plurality of compartments apart from one another without interrupting sealed content inside the respective compartments.

Aspects of the present disclosure also claim a method of using a tea bag, comprising: providing a splitable tea bag having two compartments with respective amounts of tea leaves sealed inside each compartment; and, separating the two compartments apart from one another, using a mechanism for splitting, without interrupting sealed content inside the respective compartments.

Further aspects of the present disclosure claims a method of making a splitable tea bag, comprising the steps of: making an empty tea bag with peripheral seals to hold tea leaves inside; creating an additional seal in the middle to divide the tea bag into two empty compartments, each empty compartment having an opening to add tea leaves; adding respective amounts of tea leaves into the two empty compartments through the respective openings; sealing the respective openings to create two individually sealed compartments filled with the respective amounts of tea leaves; and adding a line of perforations along an axis of the additional seal in the middle.

### BRIEF DESCRIPTION OF THE DRAWINGS

The accompanying drawings, which are incorporated herein and form a part of the specification, illustrate the disclosure and, together with the description, further serve to explain the principles of the disclosure and to enable a person skilled in the pertinent art to make and use the disclosure. The disclosure is illustrated by way of examples, and not by way of limitation, in the figures of the accompanying drawings. Note that the components of the drawings may not be drawn to scale.

FIG. 1 illustrates a conventional tea bag.

FIG. 2 illustrates the concept of a splitable tea bag, in accordance with embodiments of the disclosure.

FIG. 3 illustrates how a perforated tea bag can be split into two smaller portions, in accordance with embodiments of the disclosure.

FIG. 4 illustrates how each split portions can be used to make smaller quantity of tea in multiple cups, in accordance with embodiments of the disclosure.

FIG. 5 illustrates a side view of a splitable tea bag, in accordance with embodiments of the disclosure.

FIG. 6 illustrates how the splitable tea bag can be ripped by hand into two self-contained portions, in accordance with embodiments of the disclosure.

FIG. 7 illustrates how the self-contained portions can be used to make smaller quantity of tea in multiple cups, in accordance with embodiments of the disclosure.

FIG. 8 illustrates another embodiment for two detachable self-contained smaller portions of tea bags assembled into one tea bag, in accordance with the disclosure.

FIG. 9 illustrates the detached self-contained smaller portions shown in FIG. 8, in accordance with embodiments of the disclosure.

FIG. 10 illustrates yet another embodiment for two detachable self-contained smaller portions of tea bags assembled into one tea bag, in accordance with the disclosure.

FIG. 11 illustrates the detached self-contained smaller portions shown in FIG. 10, going into respective smaller cups, in accordance with embodiments of the disclosure.

### DETAILED DESCRIPTION

Embodiments of the present invention will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

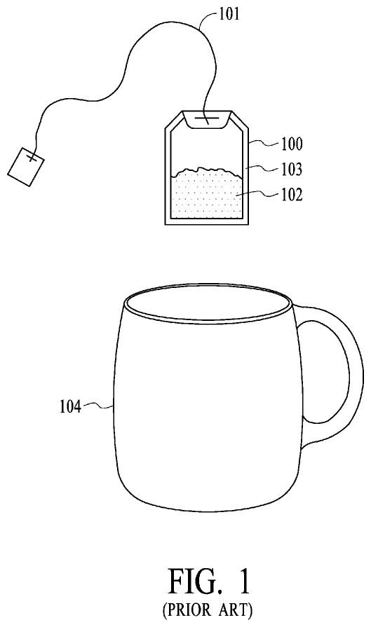

FIG. 1 illustrates a conventional tea bag 100. Tea bag 100 is a sealed pouch containing a predetermined quantity of dried tea leaves (and/or other herbal mix) 102. For ease of dipping into hot water, the tea bag 100 may have a string 101 attached to it. The tea bag 100 can be immersed in hot water inside big cup 104. For example, the capacity of the cup 104 may be of 16 oz or more or less. Tea bag 100 has a seal 103 along the periphery to keep the tea leaves fresh inside.

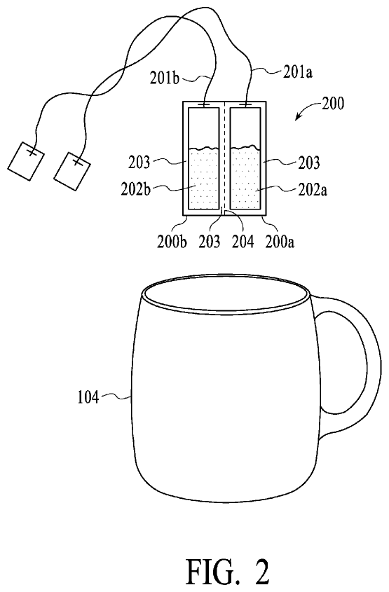

FIG. 2 illustrates the concept of a splitable tea bag, in accordance with embodiments of the disclosure. The material of the tea bag can be porous paper, silk, food-safe polymer, cotton etc. that does not lose structural integrity when steeped into hot water, for example which does not melt or stick to the tea leaves contained inside.

The splitable tea bag 200 shown here can be split into two portions 200a and 200b, though in other embodiments the tea bag 200 can be split into more than two portions. Each of the two portions 200a and 200b are self-contained, i.e., the respective quantities of tea 202a and 202b will not spill out if the splitable tea bag 200 is split into two portions 200a and 200b. This is because quantities of tea 202a and 202b are have peripheral seals 203. In other words, each of the portions 200a and 200b are individually sealed and put together into one tea bag 200. Each portion 200a and 200b can have their own dipping strings 201a and 201b attached.

The splitable tea bag 200 can be ripped along the axis 204 in the middle (though it does not have to be exactly in the middle). Seal 203 spans in the middle of the tea bag 200 around the axis 204. There may be pre-formed perforations along the axis 204. The total quantity of tea (i.e., when 202a and 202b are added together), would be substantially similar to the quantity of tea 102 contained in the conventional tea bag 100 shown in FIG. 1. Therefore, the total quantity of tea in the splitable tea bag 200 may be sufficient to make a big cup 104 of tea. Note that in the illustrative examples the two portions 200a and 200b are shown to be identical, but the disclosure is not limited to two identical splitable portions. For example, in another example (not shown), quantities 202a and 202b may be unequal, so that after splitting, portion 202a and 202b can be used to make different volumes of tea. So the axis 204 can be an axis of symmetry or can be an asymmetrical axis.

In one embodiment, a conventional tea bag 100 can be a starting point to create a splitable tea bag. One can divide the tea contained inside a conventional tea bag to two sides of the tea bag by manipulating and pushing with fingers from outside without breaking the pouch's seal, thus creating a tea-leaf-free region around the axis 204. Then a sealing mechanism can be applied around the axis 204 to create two individually sealed smaller portions 200a and 200b.

In another embodiment, a splitable tea bag is made from scratch. First, an empty tea bag is made with peripheral seals to be able to hold tea leaves inside. Before putting tea leaves inside, an additional seal is created in the middle to divide the tea bag into two empty compartments, each empty compartment having an opening to add tea leaves. This is followed by adding respective amounts of tea leaves into the two empty compartments through the respective openings, and then sealing the respective openings to create two individually sealed compartments filled with the respective amounts of tea leaves. Finally a splitting mechanism is incorporated in the tea bag (e.g., adding a line of perforations along an axis of the additional seal in the middle).

In some embodiments, smaller portions (compartments) 200a and 200b can contain two different varieties of tea. When the entire tea bag 200 is immersed in hot water, the two different varieties blend together to create a third variety with unique flavor. Or, when ripped apart, the two portions 200a and 200b produce different varieties of tea.

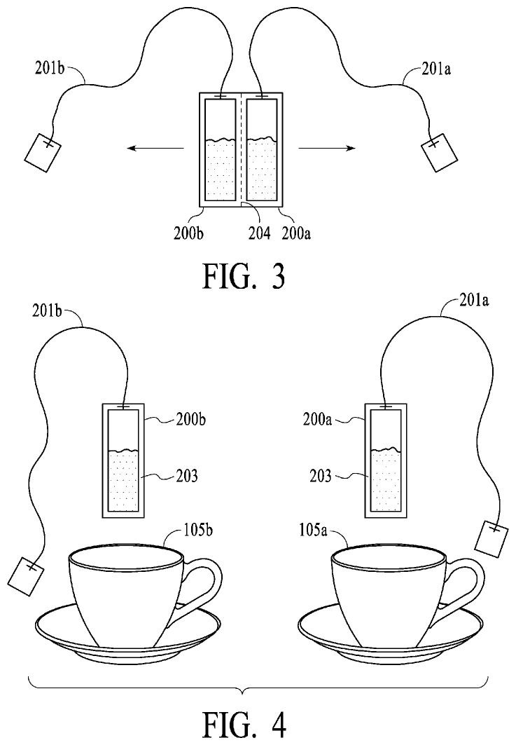

FIG. 3 illustrates how a splitable tea bag 200 can be split into two smaller portions, in accordance with embodiments of the disclosure. In this example, the split happens along the perforations aligned with the central axis 204 so that self-contained portions 200a and 200b will be separated along the mutually opposite directions of the two arrows shown.

FIG. 4 illustrates how each split portions 200a and 200b can be used to make smaller quantity of tea in multiple cups 105a and 105b, in accordance with embodiments of the disclosure. Each of the cups 105a and 105b may be smaller than the big cup 104. In an example, each of the cups 105a and 105b may have a capacity of 8 oz. When the portions are unequal, the cups 105a and 105b may hold different quantities of tea. Depending on the drinker's taste, the tea can have different degrees of dilution, as dictated by the amount of water in the individual cups.

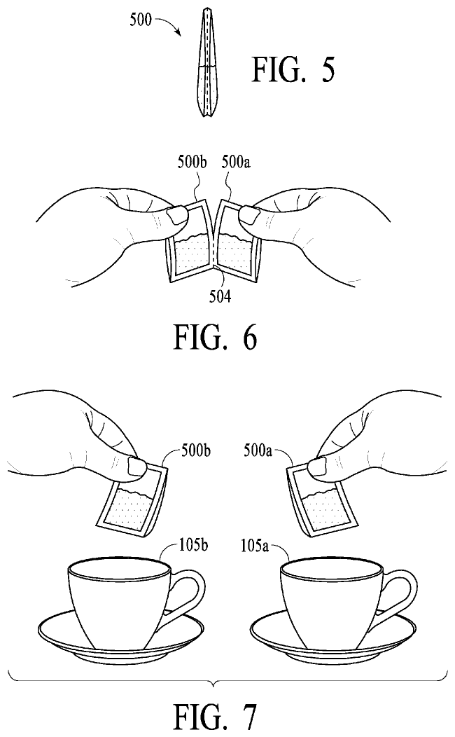

FIG. 5 illustrates a side view 500 of a splitable tea bag, in accordance with embodiments of the disclosure. In this embodiment, the dipping strings are not shown. The entire tea bag or its portions can be immersed in hot water and can be taken out with a finger or a spoon/fork after the steeping (soaking) time. Discarding the strings can also reduce wastefulness, which is a central motivation behind this disclosure.

FIG. 6 illustrates how the splitable tea bag shown in FIG. 5 can be ripped by hand into two self-contained portions 500a and 500b (similar to 200a and 200b) along the perforations 504, in accordance with embodiments of the disclosure.

FIG. 7 illustrates how the self-contained portions 500a and 500b can be used to make smaller quantity of tea in multiple cups 105a and 105b, in accordance with embodiments of the disclosure, as described above.

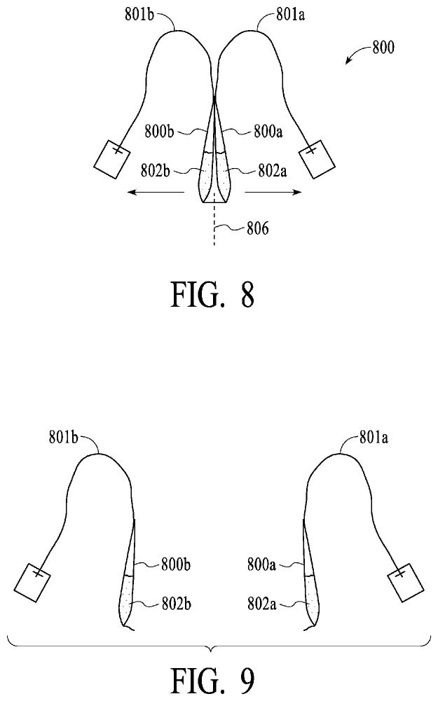

FIG. 8 illustrates another embodiment for two detachable self-contained smaller portions 800a and 800b that are assembled into one tea bag 800, in accordance with the disclosure. Each smaller portion 800a and 800b are self-contained, i.e. are sealed to hold the quantities 802a and 802b of tea inside. The smaller portions 80a and 800b may have individual dipping strings 801a and 801b, or may not have stings at all. When pulled apart along the opposite directions (shown by the arrows) away from the central axis 806, the tea bag 800 turns into two detached self-contained smaller portions, as shown in FIG. 9, in accordance with embodiments of the disclosure. The two portions 800a and 800b may be lightly glues together so that slight pulling force would pull them apart without ripping the seals.

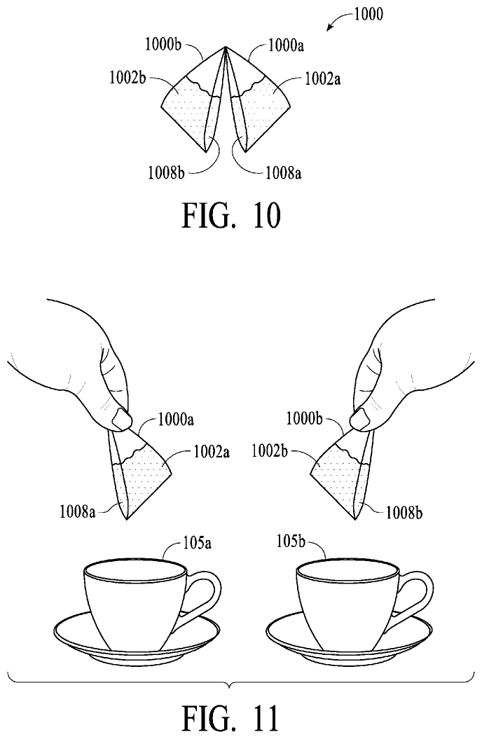

FIG. 10 illustrates yet another embodiment for two detachable self-contained smaller portions 1000a and 1000b that are assembled into one tea bag 1000, in accordance with the disclosure. Each smaller portion 1000a and 1000b are self-contained, i.e. are sealed to hold the quantities 1002a and 1002b of tea inside. The smaller portions 1000a and 1000b may be lightly attached (e.g., lightly glued together) to each other along the surfaces 1008a and 1008b facing each other. The smaller portions 1000a and 1000b may be attached together at the top, and can be pulled apart by hand by imparting slight force.

FIG. 11 illustrates the detached self-contained smaller portions 1000a and 1000b shown in FIG. 10, are going into respective smaller cups 105a and 105b, in accordance with embodiments of the disclosure.

As persons skilled in the art would appreciate in view of the present disclosure, the ability to split a tea bag into multiple splitable portions creates the flexibility of usage for a tea drinker. If the drinker is in the mood to drink a big cup of tea, he/she can use the entire tea bag (before split). If the drinker is in the mood to drink a smaller cup of tea, he/she can split the tea bag and use one smaller portion first, and save the other portion for later use. Or, two people can share one tea bag, each using a split portion at the same time. This design might be a good solution in certain scenarios, for example, during pandemic when contact and sharing is minimized.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” In addition, the articles “a” and “an” as used in this application and the appended claims should generally be construed to mean “one or more” unless specified otherwise or clear from context to be directed to a singular form.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment.

The above description is intended to be illustrative and not restrictive. For example, the above-described examples (or one or more aspects thereof) may be used in combination with each other. Other implementations can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description, with each claim standing on its own as a separate implementation, and it is contemplated that such implementations can be combined with each other in various combinations or permutations. The scope of the implementations of the disclosure should be determined with reference to the appended claims, along with the full scope of equivalents to which such claims are entitled.

In the drawings, which are not necessarily drawn to scale, like numerals may describe similar components in different views. Like numerals having different letter suffixes may represent different instances of similar components. The drawings illustrate generally, by way of example, but not by way of limitation, various implementations discussed in the present document.

What is claimed is:

1. A splitable tea bag, comprising:
a plurality of compartments with respective amounts of tea leaves sealed inside each compartment; and
a mechanism for splitting the plurality of compartments apart from one another without interrupting sealed content inside the respective compartments.

2. The tea bag of claim 1, wherein the mechanism for splitting is a line of perforation along an axis that separates a first compartment and a second compartment of the plurality of compartments, wherein the first compartment and the second compartment are torn apart along the line of perforation by application of force by hand.

3. The tea bag of claim 1, wherein each of the compartments contains substantially equal amount of tea leaves sealed inside.

4. The tea bag of claim 1, wherein the mechanism of splitting is along a line of symmetry.

5. The tea bag of claim 1, wherein the mechanism of splitting is not along a line of symmetry, such that different compartments have different sizes.

6. The tea bag of claim 1, wherein at least one of the compartments contains a first amount of tea leaves sealed inside that is different from a second amount of tea leaves sealed inside a different compartment of the tea bag.

7. The tea bag of claim 1, wherein at least one of the compartments contains a first variety of tea leaves sealed inside that is different from a second variety of tea leaves sealed inside a different compartment of the tea bag.

8. The tea bag of claim 1, wherein a first compartment has a first surface and a second compartment has a second surface, wherein the first surface and the second surface are facing each other, and the first surface and the second surface are lightly glued together, such that the first compartment and the second compartment are pulled apart from one another by application of force by hand.

9. The tea bag of claim 6, wherein the first surface and the second surface are connected at the top that can split easily when pulled apart.

10. The tea bag of claim 1, wherein each compartment has a respective string attached for dipping in hot liquid.

11. The tea bag of claim 1, wherein sealed content inside at least one of the compartment comprises a herb other than tea.

12. A method of using a tea bag, comprising:
providing a splitable tea bag having two compartments with respective amounts of tea leaves sealed inside each compartment; and
separating the two compartments apart from one another, using a mechanism for splitting, without interrupting sealed content inside the respective compartments.

13. The method of claim 11, further comprising:
immersing both compartments in a larger quantity of hot liquid.

14. The method of claim 12, further comprising:
immersing one compartment in a smaller quantity of hot liquid; and
saving the other compartment for later use such that the two compartments are used sequentially.

15. The method of claim 12, further comprising:
immersing one compartment in a smaller quantity of hot liquid in a first cup; and
immersing one compartment in a smaller quantity of hot liquid in a second cup, such that both the compartments are used in parallel.

16. The method of claim 12, wherein the mechanism for splitting is a line of perforation along an axis that separates a first compartment and a second compartment of the plurality of compartments, wherein the first compartment and the second compartment are torn apart along the line of perforation by application of force by hand.

17. The method of claim 12, wherein a first compartment has a first surface and a second compartment has a second surface, wherein the first surface and the second surface are facing each other, and the first surface and the second surface are lightly glued together, such that the first compartment and the second compartment are pulled apart from one another by application of force by hand.

18. The tea method of claim 17, wherein the first surface and the second surface are connected at the top that can split easily when pulled apart.

19. The method of claim 12, wherein each compartment has a respective string attached for dipping in hot liquid.

20. A method of making a splitable tea bag, comprising:
making an empty tea bag with peripheral seals to hold tea leaves inside;
creating an additional seal in the middle to divide the tea bag into two empty compartments, each empty compartment having an opening to add tea leaves;
adding respective amounts of tea leaves into the two empty compartments through the respective openings;
sealing the respective openings to create two individually sealed compartments filled with the respective amounts of tea leaves; and
adding a line of perforations along an axis of the additional seal in the middle.
